(19) United States
(12) Patent Application Publication
(10) Pub. No.: US 2007/0234509 A1
(43) Pub. Date: Oct. 11, 2007

(54) Door closing actuator

(76) Inventor: Peter David Etlicher, Rice Lake, WI (US)

Correspondence Address: PERMAN & GREEN, 425 POST ROAD, FAIRFIELD, CT, 06824, US

(21) Appl. No.: 11/399,180

(22) Filed: Apr. 6, 2006

(51) Int. Cl. E05F 3/02

(52) U.S. Cl. 16/66

(57) ABSTRACT

A door closing actuator for closing a door in a frame is provided. The door closing actuator comprises a cylinder having a first end adapted to be attached to the door or the door frame. The cylinder has a second end opposite the first end and a stop located there between. A rod is movable within the cylinder with the rod protruding from the second end of the cylinder. The rod is attachable to the door or the door frame. A locking device is movably connected to the cylinder for locking the rod relative to the cylinder with the locking device having a locking member and an actuation member. The actuation member has a locking member contact portion adapted to contact the locking member. The locking member is disposed in the cylinder between the second end and the contact portion. The actuation member engages and moves the locking member from a free position to a locking position in which the locking member engages the rod. Movement of the rod relative to the cylinder with the locking member in the locking position causes the actuation member to disengage the locking member and further causes the locking member to engage the stop of the cylinder.

### BACKGROUND

1. Field

The exemplary embodiment disclosed herein relates to door closing actuators and, more particularly, to locking door closing actuators.

2. Brief Description of Related Developments

Door closing actuators are provided as spring loaded cylinders that urge a door to a closed position in a controlled fashion such that a user does not have to close the door, for example, when carrying groceries. Door closing actuators may be provided with a locking feature whereby the user may lock the door in an opened position. An example of such a locking feature is disclosed in U.S. Pat. No. 6,615,449 whereby a user may lock a door in an opened position. Problems arise with existing locking mechanisms where their use is not intuitive or where there is over complexity in the approach. Accordingly, there is a desire to provide a door closing actuator having a locking mechanism whereby the use is intuitive in a simplified and reliable design.

### SUMMARY OF THE EXEMPLARY EMBODIMENTS

In accordance with one exemplary embodiment, a door closing actuator for closing a door in a frame is provided. The door closing actuator comprises a cylinder having a first end adapted to be attached to the door or the door frame. The cylinder has a second end opposite the first end and a stop located there between. A rod is movable within the cylinder with the rod protruding from the second end of the cylinder. The rod is attachable to the door or the door frame. A locking device is movably connected to the cylinder for locking the rod relative to the cylinder with the locking device having a locking member and an actuation member. The actuation member has a locking member contact portion adapted to contact the locking member. The locking member is disposed in the cylinder between the second end and the contact portion. The actuation member engages and moves the locking member from a free position to a locking position in which the locking member engages the rod. Movement of the rod relative to the cylinder with the locking member in the locking position causes the actuation member to disengage the locking member and further causes the locking member to engage the stop of the cylinder.

In accordance with another exemplary embodiment, a door closing actuator for closing a door in a frame is provided. The door closing actuator comprises a cylinder having a first end adapted to be attached to the door or the door frame. The cylinder has a second end opposite the first end and a stop located there between. A piston assembly is provided within the cylinder with the piston assembly having a rod protruding from the second end of the cylinder and with the rod being attachable to the door or the door frame. A locking device is movably connected to the cylinder for locking the rod to the cylinder. The locking device has a locking member and an actuation member capable of actuating the locking member from an unlocked to a locked position in which the locking member engages the rod. The locking member is movably mounted on the cylinder.

In accordance with another exemplary embodiment, a door closing actuator for closing a door in a frame is provided. The door closing actuator comprises a cylinder having a first end adapted to be attached to the door or the door frame. The cylinder has a second end opposite the first end and a stop located there between. A piston assembly is provided within the cylinder. The piston assembly has a rod protruding from the second end of the cylinder. The rod is attachable to the door or the door frame. The piston assembly is spring loaded against the cylinder and applies a returning force to urge the door to a closed position within the frame. A locking device is movably connected to the cylinder for locking the rod relative to the cylinder. The locking device has a locking member and an actuation member. The actuation member has a locking member contact portion adapted to contact the locking member. The locking member is disposed in the cylinder between the second end and the contact portion. Movement of the actuation member from a neutral state position to a loaded state position moves the locking member from a free position to a locking position engaging the rod without movement of the rod relative to the cylinder. The actuation member remains in the loaded state position until movement of the door toward the closed position locks the rod in a locked position relative to the cylinder and returns the actuation member to the neutral state position and further causes the locking member to engage the stop of the cylinder. Movement of the door away from the closed position releases the locking member from the locked position returning the locking member to the free position and disengaging the rod.

### BRIEF DESCRIPTION OF THE DRAWINGS

The foregoing aspects and other features of the present invention are explained in the following description, taken in connection with the accompanying drawings, wherein:

FIG. 1 is a perspective view of a door having a door closing actuator incorporating features in accordance with an exemplary embodiment;

FIG. 2 is a perspective view of the door closing actuator in FIG. 1;

FIG. 3 is an exploded view of the door closing actuator;

FIG. 4 is an exploded view of an end of the door closing actuator;

FIG. 5 is a view of a housing of the door closing actuator;

FIG. 6 is another view of the housing in FIG. 5;

FIG. 7 is a plan view of the housing in FIG. 5;

FIG. 8 is a perspective view of a locking member of the door closing actuator;

FIG. 9 is a section view of the door closing actuator with the actuator in a first position;

FIG. 10 is an enlarged section view of the end of the door closing actuator of FIG. 9;

FIG. 11 is another section view of the door closing actuator with the actuator in another position;

FIG. 12 is an enlarged section view of the end of the door closing actuator in the position shown in FIG. 11;

FIG. 13 is still another section view of the door closing actuator with the actuator in yet another position; and

FIG. 14 is an enlarged section view of an end of the door closing actuator of FIG. 13

### DETAILED DESCRIPTION OF THE EXEMPLARY EMBODIMENT(s)

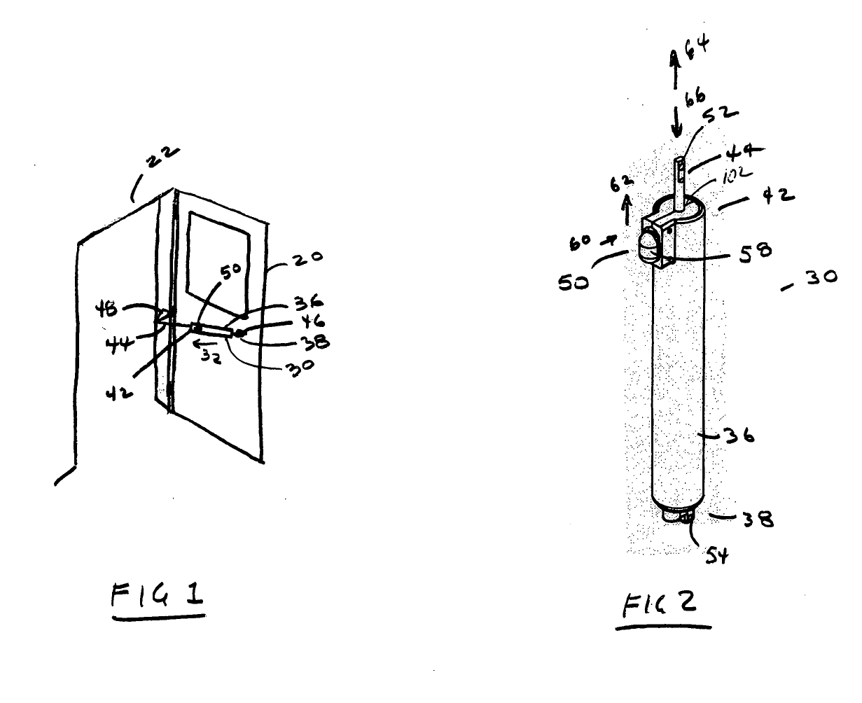

Referring to FIG. 1, there is shown, a perspective view of a door 20 and a door closing actuator 30, incorporating features in accordance with an exemplary embodiment, connecting the door 20 to a frame 22. Referring also to FIG. 2, there is shown a perspective view of door closing actuator 30. Although the exemplary embodiments will be described with reference to the embodiments shown in the drawings, it should be understood that the exemplary embodiments can be embodied in many alternate forms of embodiments. In addition, any suitable size, shape or type of elements or materials could be used.

In FIG. 1, door 20 is shown in an opened position and is pivotally mounted within door frame 22. Door closing actuator 30 provides a closing force 32 urging door 20 to a closed position within frame 22. Door closing actuator 30 comprises a cylinder 36 having first end 38 adapted to be attached to 20 door or the door frame 22. Cylinder 36 has second end 42 opposite first end 38. A piston assembly is provided within cylinder 36 with the piston assembly having rod 44 protruding from second end 42 of cylinder 36. The piston assembly is biased against cylinder 36 and when displaced from an initial position, applies a returning force via rod 44, for example to urge door 20 to a closed position within frame 22. Rod 44 is attachable to door 20 or door frame 22. For example, brackets 46, 50 may be provided respectively on door 20 and frame 22 to mount corresponding ends of actuator 30. In the exemplary embodiment shown in FIG. 1, bores 52, 54 are provided on rod 44 and first end 38 for fasteners that allow mounting to brackets 46, 50. In alternate embodiments, attachment of rod and cylinder may be performed in any other desired manner. Locking device 50 is movably connected to cylinder 36 for locking rod 44 to cylinder 36. As will be described in greater detail below, locking device 50 has a locking member and actuation member 58. Actuation member 58 is capable of actuating the locking member from an unlocked to a locked position in which the locking member engages rod 44. Here, the locking member is movably mounted to the cylinder within end 42 of cylinder 36. When locked to the rod 34 the locking member further engages a stop located between first end 38 and second end 42 of cylinder 36 to lock the rod and cylinder and fix the position of door 20. The actuation member is movable between disengaged, or neutral state, and engaged, or loaded state positions. In FIG. 2, actuation member 58 is shown in the disengaged position. The terms engaged and disengaged are used in regards to the positions of the actuation member for exemplary purposes, and the positions of the actuation member may be described in any other suitable terms. With the actuation member in the disengaged position, the locking device allow rod 44 to move freely axially in directions indicated by arrows 64, 66 (e.g. opening door 20 moves rod in direction 64, out, and closing door 30 moves rod in direction 66, in). With the actuation member in the engaged position, the locking device 50 causes the rod to become locked to the cylinder. The actuation member is moved automatically from engaged to disengaged positions as the rod becomes locked to the cylinder. Where a user wishes to lock door 20 in a given opened position, the user may press actuation member 58 in direction 60 until member 58 snaps in direction 62, maintaining actuation member 58 in a loaded state position, and open door 20 to a desired position. Upon releasing door 20, door 20 becomes locked in position and snaps member 58 back to the disengaged position. To unlock the door from the locked position, the user simply urges the door in an opening direction and releases the door where actuator 30 may then close door 20. In this manner, a user may simply and intuitively lock door 20 in a desired position and release door 20 from the locked position allowing actuator 30 to close door 20 within frame 22.

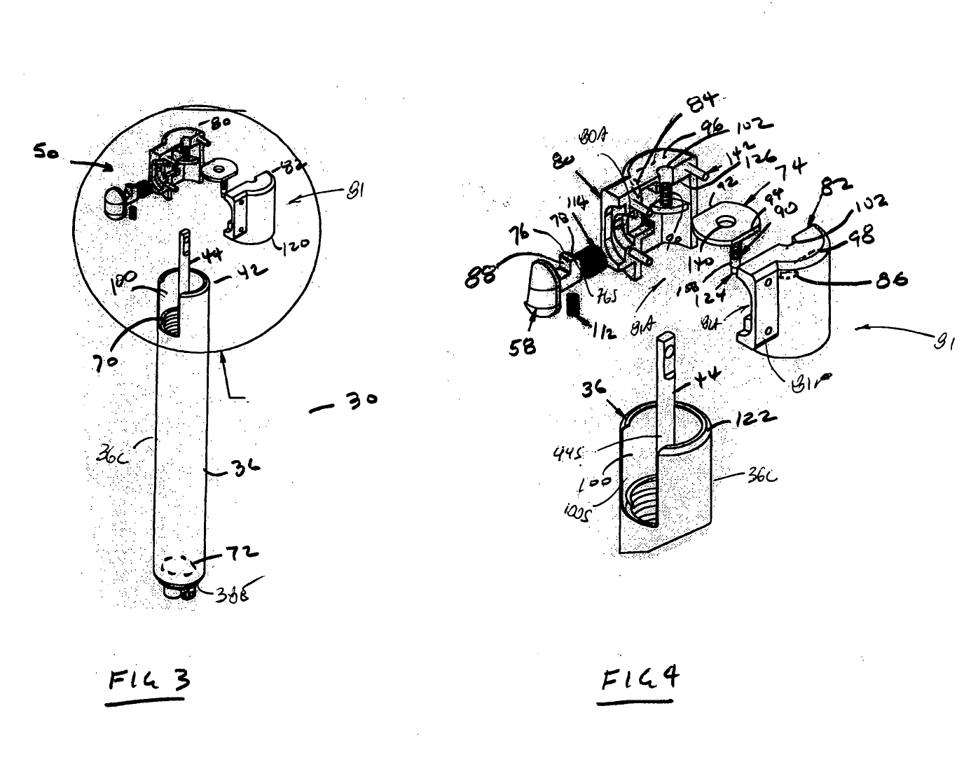

Referring now also to FIG. 3, there is shown an exploded view of door closing actuator 30. Cylinder 36 generally includes a sleeve or shell 36C, that in the exemplary embodiment shown, may have a generally cylindrical shape, though in alternate embodiments the cylinder shell may have any desired shape. The cylinder may have any desired diameter. In the exemplary embodiment, the shell 36c may be a one piece member of unitary construction (e.g. drawn tubing, rolled sheet) made of nay suitable material, such as metal or plastic. In alternate embodiments, the shell may be formed in any other desired manner. The piston and rod assembly is located in the cylinder shell 36C. The piston 72 may be generally conformal to the bore formed by the cylinder shell 36C. As may be realized the piston 72 may be movably seated against the bore periphery as desired to assist in controlling or regulating the travel rate of the piston 72 as it is being actuated by for example opening and closing the door (see FIG. 1). For example, the cylinder 36 may be air filled (though in alternate embodiments the actuator cylinder may hold any other desired fluid as a piston rate regulating media, or may employ any other desired mechanical piston plate regulator), and the piston seat against the cylinder bore may have suitable seals for effecting a desired air flow rate around the piston as the piston moves back and forth inside the cylinder. This, as may be realized enables effective control of the travel rate of the piston. By way of example, the piston 72 may seal against shell 36C so that there is substantially no bypass air flow around piston 72 as it is moved inside cylinder 36. Travel of the piston may be enabled, for example, by venting cylinder 36 (e.g. through a regulator passage that has a desired flow rate and may also allow adjustment of the flow rate) and/or porting the piston (e.g. providing flow ports through the piston sized and shaped for effecting desired fluid flow) so that resistance of travel rate regulating fluid in the cylinder against the piston 72 results in desired piston travel rates.

Referring still to FIG. 3, the ends of the cylinder shell 36C are closed. At one end 38 of the cylinder, the shell may be closed by an end wall 38E, such as a plug, that may be affixed to the shell in any desired manner (e.g. threaded engagement, press fit, etc.). By way of example, the end wall 38E may be provided with the aforementioned venting (such as an adjustable vent valve not shown in the figures) for regulating the piston travel rate. Also, the end wall may have extension arms or other suitable dependent members with fastener bore(s) 54 (see also FIG. 2) for fastening cylinder end 38 to the corresponding mounting bracket 46 in the exemplary embodiment. The opposite end 42 of the cylinder is closed by housing assembly 81 that houses the locking device 50 as will be described further below.

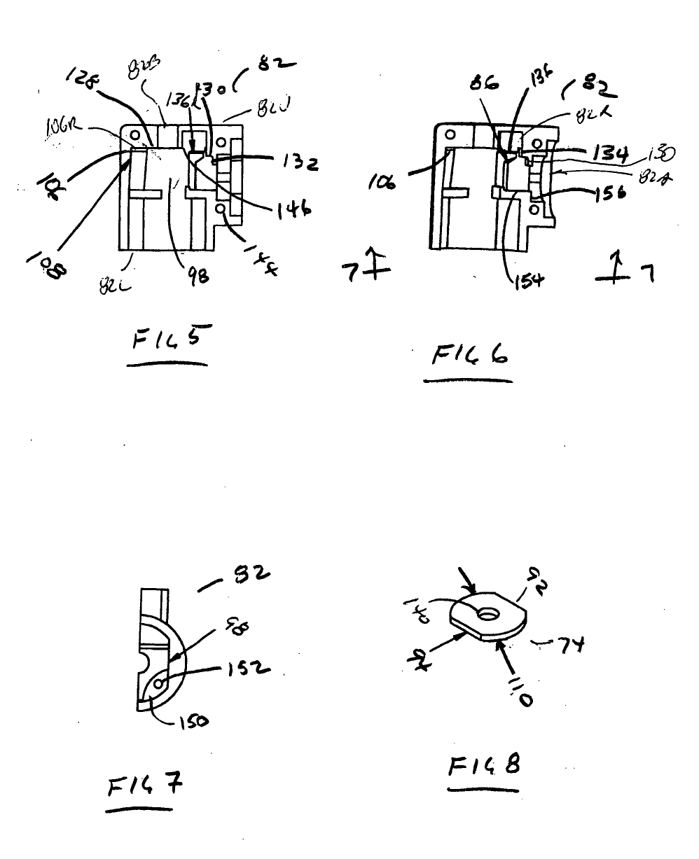

In the exemplary embodiment, the rod is biased in the cylinder by spring 70, provided, as shown in FIG. 3, within cylinder 36 urging rod 44 in direction 66. In the exemplary embodiment spring 70 seats and presses against piston 72 that is coupled to rod 44 (see also FIG. 9). In the exemplary embodiment, the upper portion of spring 70 seats against a lower portion 120 of housing assembly 81 (see also FIG. 9). In this manner, spring 72 is compressed between the lower portion 120 of housing 80, 82 and piston 72 when rod 44 is extended from cylinder 36. In alternate embodiments, other methods of spring loading rod 44 may be provided. Referring also to FIG. 4, there is shown an exploded view of cylinder end 42 of door closing actuator 30. Housing 81, may be die cast aluminum or otherwise fabricated in any suitable manner from any suitable material (such as metal, plastic, etc.). In the embodiment shown, housing 81 is shown as a two piece 80, 82 construction. In alternate embodiments, the housing may be of one piece or unitary construction, for example where housing is integrated into piston 36 in a unitary construction. In the exemplary embodiments pins 142 are provided with mating bores 144 to allow housings 80, 82 to be precisely mated to form a unitary housing. Housing assembly 81 is slid into the wall 100 of cylinder shell 36C and captured, in the exemplary embodiment, by folded over portion 122 of shell 36C. In alternate embodiments, the housing 31 may be retained to the cylinder shell in any other manner, such as by keying, striking, fastening. In other alternate embodiments, the housing may be mounted on the outside of the cylinder shell. As seen best in FIG. 4, the cylinder shell 36C, in the exemplary embodiment has a slot 100S formed therein. The housing assembly 81 may have a portion 81P that protects through the slot 100S in the shell. In the exemplary embodiment shown in FIG. 4, the slot 100S has an opening at one end 42 of the cylinder shell, allowing the housing assembly 81 to be inserted into the shell with portion 81P slid into slot 100S. In the exemplary embodiment, the housings 80, 82 are generally similar to each other and will be described in greater detail below with specific reference to housing 82 (except as otherwise noted). FIGS. 5-7, respectively show two section views and a bottom plan view of the housing 82 in accordance with the exemplary embodiment. As noted before, in the exemplary embodiment the end surface 82C of the housing forms a seat for piston bias spring 72. In alternate embodiments, the bias spring may be seated against any other suitable portion of the housing or cylinder 36. The other end 82U of the housing is substantially closed in the exemplary embodiment by a wall. The end wall 82U may have a bore 82B (in the exemplary embodiment each housing 80, 82 has opposing scallops that form bore 10U when the housings 80, 82 are assembled) for rod 44 to extend from end 42 of the cylinder. The bore 102, (see also FIG. 2) may be sized to act as a bush for rod 44, axially guiding and allowing the rod to slide freely relative to housing 81.

As previously described, locking device 50 is movably connected to cylinder 36 for locking rod 44 relative to cylinder 36. Locking device 50 generally has locking member 74 and actuation member 58. Locking member 74 is spring loaded by springs 90 against supporting surfaces 126, 128 (see also FIG. 4). In the exemplary embodiment the locking member bias spring(s) 90 may be mounted to housing(s) 80, 82, eccentric relative to rod 44. As seen also in FIG. 10, in the exemplary embodiment spring(s) 90 are offset from rod 44, and rod 44 does not extend through the spring(s). Seats 158 (see FIG. 4) mate with springs 90 where seats 158 have locating pins 124. Seat 158 is supported by surface 150 and pin 124 may be located by pilot hole 152 (see FIG. 7). In this manner, springs 90 are positively located within housing 80, 82 and offset from the rod 44. In alternate embodiments more or less spring(s) 90 may be provided to seat locking member 74 against surface 128, for example, a single spring 90 may be provided concentric or otherwise offset from rod 44.

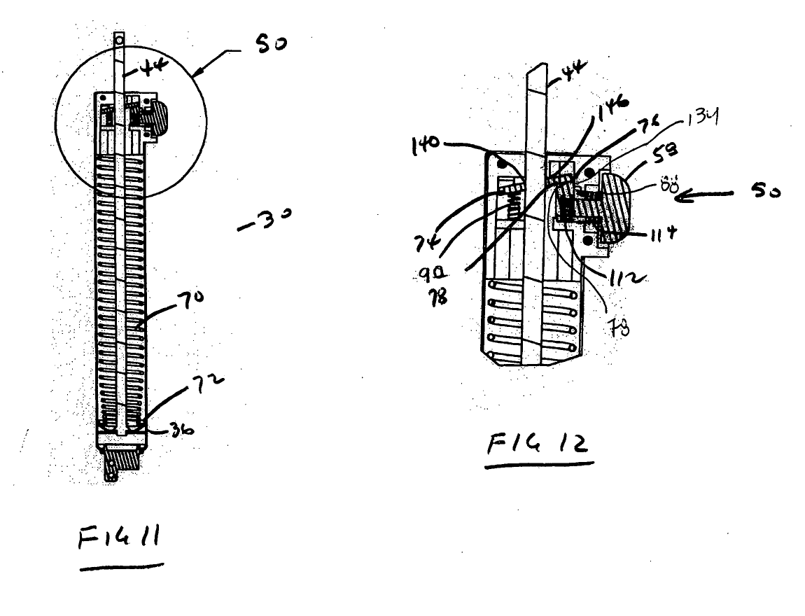

As seen in FIG. 4, in the exemplary embodiment the housing 81 has an aperture 81A through which the actuation member 58 housed in housing 81 extends from inside the housing to outside the housing. In the exemplary embodiment, each housing 80, 82 (see also FIG. 6) may be shaped to form a corresponding portion 80A, 82A of aperture 81A, so that the aperture is defined upon assembly of housing 81. In alternate embodiments, the aperture may be formed in but one of the housing portions. Actuation member 58 has a locking member contact portion 76, 78 adapted to contact locking member 74 when transitioning from disengaged position (see FIG. 10) to an engaged position (see FIG. 12). In the exemplary embodiment, contact portion 76 may have a stop 76S thereon to contact housing 80, 82 at surface 130 (see FIG. 5) when in the disengaged position. Actuation member 58 further has catch portion 88 adapted to be caught by surface 132 of housing 82 when in the disengaged position and by surface 134 of housing 82 when in the engaged position (see FIG. 12). Actuation member 58 is spring loaded, for example by spring 114, outward relative to the cylinder 36. Further, actuation member 58 is spring loaded by spring 112 in a generally axial direction, but offset relative to the centerline of cylinder 36. The arrangement of actuation member bias springs 112, 114 shown in FIGS. 4-14 is merely exemplary, and in alternate embodiments the spring(s) (e.g. more or fewer springs may be used) may have any other desired configuration and arrangement. Generally, bias springs 112, 114 bias the actuation member in two directions angled relative to each other. Actuation member 58 may be captured within housing 81 so as not to be removable when housing 81 is assembled, but still being movable between the disengaged position, and to the engaged position. By way of example, when in the engaged position, contact portion 76 is preloaded against surface 130 of housing 81 by spring 112, and catch portion 88 is spring loaded against step portion 132 of housing 82 (see FIG. 5). When in the engaged position, contact portion 76 has ramped or camming portion 78 (see FIGS. 4 and 10), preloaded against locking member 74 by spring 112. Additionally, while in the engaged position, catch portion 88 is spring loaded against step portion 134 (see FIG. 6) by spring 114.

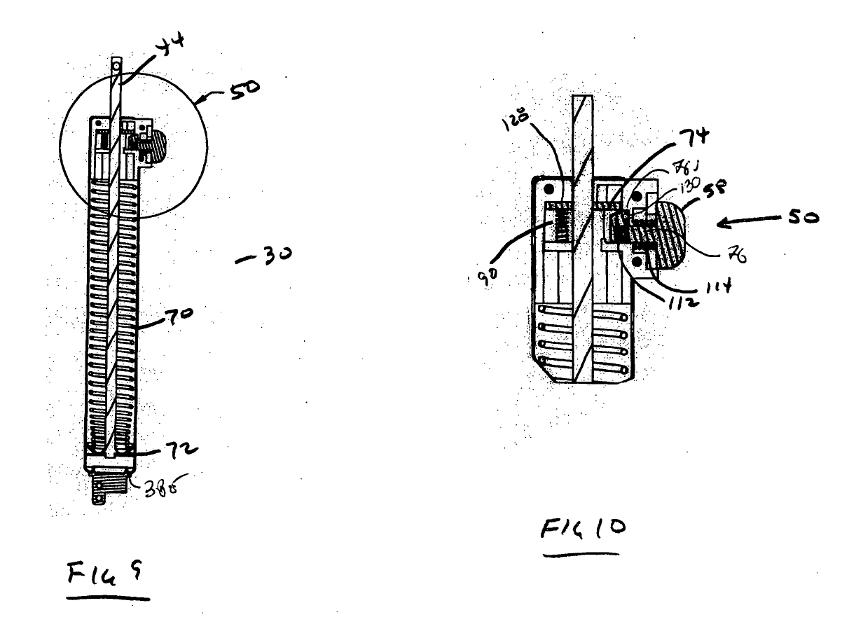

As seen in FIG. 4, the locking member 74 of locking device 150 is also disposed in housing 81 mounted within cylinder 36. In the embodiment shown, housing 81 engages the locking member and, axially positions locking member 74 generally concentric with the rod 44 as will be described further below. The locking member 74 is movable relative to the housing between unlocked or free position and locked position in which the locking member is respectively unlocked and locked to the rod 44. Referring now to FIG. 8, there is shown a perspective view of locking member 74 in accordance with the exemplary embodiment. The locking member shown in the figures has an exemplary shape, and in alternate embodiments the locking member may have any other desired shape and configuration. Locking member 74 may be a one piece member formed from sheet metal or any other suitable material. The locking member in this embodiment may have curved or rounded portions 110 and flats 92, 94. Bore 140 is provided to allow rod 44 to pass through locking member 74 unimpeded when locking member 74 is in the unlocked position. Bore 140 is sized such that, upon rotation of locking member 74 from the unlocked position to the locking position, bore 140 engages rod 44, locking the locking member on rod 44. As will be described further below bore 140 may be sized and positioned to provide sufficient clearance around rod 44 such that rod 44 does not come into contact with bore 140 or locking member 74 when locking member 74 is in the unlocked position. In alternate embodiments, other suitable shapes of locking member may be provided, for example, where locking member 74 is not held by the housing in a position concentric with rod 44. The outer surface 44S of the rod, engaged by the locking member when locked to the rod, may have a substantially smooth surface or a roughened surface (e.g. by knurling or other surface roughing means) as desired.

In the exemplary embodiment locking member 74 is mounted on the housing 81 and held by housing 81 in the free position against surfaces 126, 128 so that, locking member 74 bore 140 does not contact rod 44. As seen best in FIGS. 5-6, in the exemplary embodiment housing 82 has locating inner surface 106 that generally conforms to the perimeter shape of the locking member. For example, inner surface 106 may have rounded portions 106R, 136R and flat portions 96, 98. Rounded portions 106R, 136R cooperate with rounded portions 110 of locking member 74 to position the locking member relative to rod 44. For example, the clearance between rounded portion 110 of locking member 74 and the housing locating surface 106, 136 may be, for example, 0.005″ on each side and the clearance between the bore 140 and rod diameter 44 may be 0.007″ on each side. In alternate embodiments, other clearances may be provided. In this manner, locking member 74 remains concentric with rod 44 without contacting rod 44. Tapered portion 108 guides locking member 74 into locating surface 106, for example, when transitioning from the locking position to the unlocked position. In the embodiment shown, the flats 92, 94 of locking member 74 may engage a mating flat portion 96, 98 of housing 81 preventing rotation of locking member 74 relative to cylinder 36 about an axis of rotation generally parallel to centerline of rod 44. As may be realized, the interface between flats 92, 94 on the locking member and flat portions 96, 98 further aid in preventing the locking member from resting on the rod 44 until the locking member is locked to the rod. In alternate embodiments, other suitable shapes or features may be provided to prevent such rotation. In other alternate embodiment the locking member may be mounted on the housing in any other desired manner. In still other alternate embodiments, the locking member may be mounted on the rod. In the exemplary embodiment, supporting surfaces 126, 128 of housing 81 (see FIGS. 5-6) support locking member 74 when in the unlocked position. Housing 81 may have a fulcrum about which locking member 74 pivots, such as edge 146, when transitioning from the unlocked position to the locking position. In the exemplary embodiment, housing 81 may also have snub 86 is provided as a stop for locking member 74. The snub 86 snubs movement of locking member 74 when locked to rod 44 and the rod 44 is retracting (e.g. moving in direction 66 in FIG. 2) thereby stopping the retraction of the rod. As seen best in FIG. 6, snub 86 may be offset from stop 130 in the extraction direction so that snubbing of the locking member 74 by snub 86 allows the actuation member 58 to disengage the locking member. Camming surface (not shown) on the contact portion or the housing 81 may cam the actuation member 58 biased outward by spring 114 (see also FIG. 12), to the disengaged position with the contact portions 76 abutting detent surface 130. In alternate embodiments the snub and the disengaged detent in the housing may not be offset.

Movement of actuation member 58 from its disengaged position to its engaged position causes actuation member 58 to engage locking member 74 and moves locking member 74 from its unlocked position to its locking position in which bore 140 of locking member 74 engages rod 44 so that locking member is locked to rod 44 (without axial movement of rod 44 relative to cylinder 36). In the exemplary embodiment locking member 74 is located between second end 42 and contact portion 76, 78 of actuation member 58. The engaged position is maintained and held by actuation member 58 where catch surface 88 engages housings 80, 82 at shelf 134. The actuation member 58 may remain in the engaged position (unless manually returned to disengaged) until retracting movement of rod 44 in the direction indicated by arrow 66 locks rod 44 upon locking member 74 engagement with snub or stop 84, 86 of cylinder 36, in a locked position relative to cylinder 36 and returns actuation member 58 to the disengaged position. In this manner, the movement of rod 44 relative to cylinder 36 with locking member 74 in the locking position causes actuation member 58, in the exemplary embodiment, to disengage locking member 74 and further causes locking member 74 to engage stop 84, 86 of cylinder 36. In alternate embodiments the actuation member may not disengage the locking member when the rod movement is topped by the snub, snubbing the locking member, and the actuation member is returned to the disengaged position. Subsequent extending movement of rod 44 (direction 64 in FIG. 2) from the stopped position allows spring(s) 90 to reseat locking member in the unlocked position and releases locking member 74 from the locked position, returning locking member 74. to the unlocked position and disengaging rod 44.

Referring now to FIG. 9, there is shown a section view of door closing actuator 30. Referring also to FIG. 10, there is shown an enlarged section view of an end of the door closing actuator 30 of FIG. 9. In the state of the embodiment shown, locking member 74 is in the unlocked position and actuation member 58 is in the disengaged position. Spring(s) 90 in housing 81, as noted before urges locking member 74 toward the unlocked position against surface 128 of the housing. As seen in FIGS. 9-10 spring(s) 90 is positioned offset from rod 44, such as on an opposite side of rod 44 relative to actuation member 58. Actuation member 58 is spring loaded outward relative to rod 44 by spring 114 and is held in the disengagement detent formed by stop surface 130. In the state shown, locking member 74 does not contact rod 44 when locking member 74 is in the free position. In the state shown, rod 44 is free to move axially relative to cylinder 36.

Referring now to FIG. 11, there is shown another section view of door closing actuator 30. Referring also to FIG. 12, there is shown an enlarged section view of the end of the door closing actuator 30 in FIG. 11. In the embodiment shown in FIGS. 11-12, locking member 74 is in the locking position and actuation member 58 is in the engaged position. In this position, actuation member engages locking member 74 with contact portion 78 causing the locking member pivot about fulcrum 146 of the housing. As seen best in FIGS. 5-6, housing 81 has a recess 82R enabling rotation of locking member 74 about fulcrum 146, until the locking member engages and locks to the rod 44. In transitioning from the disengaged position in of FIG. 9 to the engaged position of FIG. 11, actuation member 58 is moved in an axial direction 62 (see FIG. 2) relative to rod 44, actuation member 58 overcomes spring 90, from the load of spring 112, thereby moving locking member 74 from the unlocked position to the locking position. Spring 90 continues to urge locking member 74 toward the free position but is over come by spring 112.

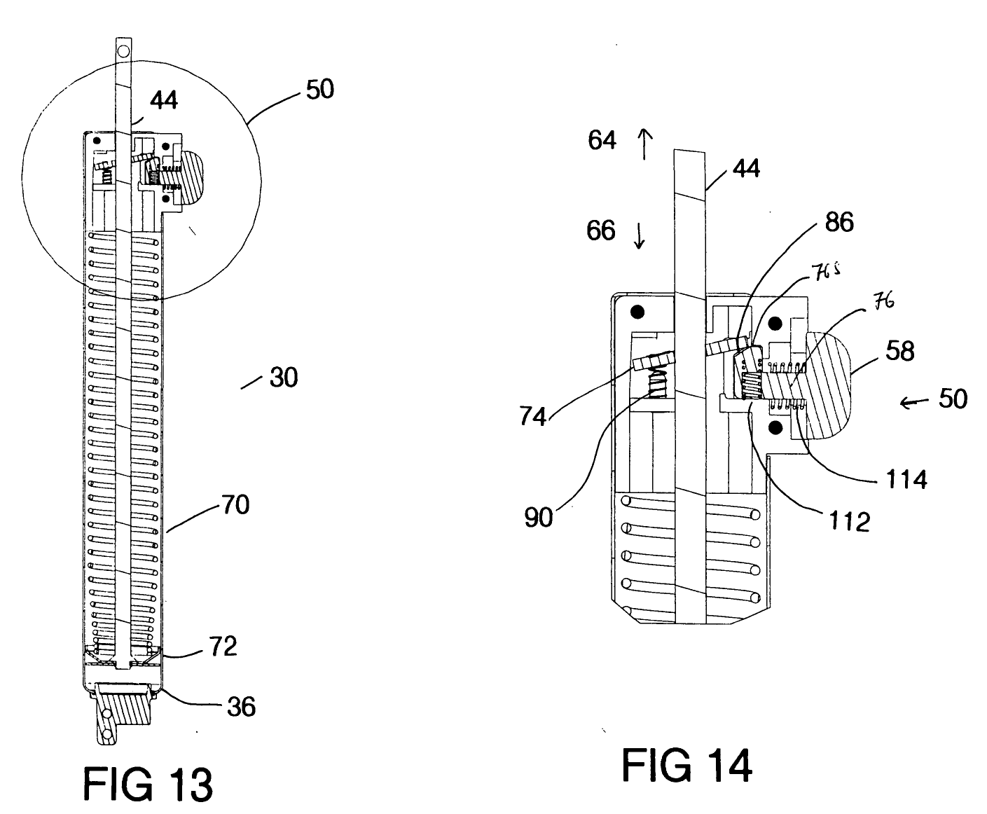

Referring now to FIG. 13, there is shown still another section view of door closing actuator 30. Referring also to FIG. 14, there is shown an enlarged section view of the end of the door closing actuator 30 of FIG. 13. In the exemplary embodiment shown, locking member 74 is shown in the locking position snubbed against snub 84, 86, with rod 44 in a locked position relative to cylinder 36. Actuation member 58 is shown in the disengaged position. Engagement between locking member 74 and snubs 84, 86 stops movement of rod 44 relative to cylinder 36. The transition between the states of FIG. 11 and FIG. 13 is accomplished upon retracting, movement of the rod 44 in direction 66, for example when door 20 moves in a door closing, direction, with locking member 74 in locking position. In the exemplary embodiment inward movement of rod 44 relative to cylinder 36 causes the locking member 74, locked to rod 44, to move actuation member 58 (in a direction opposite to that indicated by arrow 62) disengage the locking member 74. Further, in the exemplary embodiment locking member 74 may engage snubs 84, 86, causing rod 44 to lock position relative to cylinder 36 before the actuation member 58 returns to its disengaged position. As noted before, in the exemplary embodiment, the actuation member may disengage the locking member and return to the disengaged position under bias from spring 114. As may be realized, spring 90 continues to urge locking member 74 toward the free position but is over come by the combination of piston spring 70 urging rod 44 and locking member 74 against the stop 84, 86. The transition between the locking and snubbed position of FIG. 13 and unlocked position of FIG. 9 is accomplished upon extending movement of rod 44 and to unlock the rod from the position. For example, the user simply urges the door 20 in an opening direction, and releases the door where actuator 30 may then close door 20. Extension of rod 44 causes locking member 74 to disengage stop 86, and allows spring 90 to urge locking member 74 to the unlocked position and releasing rod 44 which may then move freely relative to the cylinder 34.

It should be understood that the foregoing description is only illustrative of the exemplary embodiments. Various alternatives and modifications can be devised by those skilled in the art without departing from the exemplary embodiments. For example, the aforementioned features of the exemplary embodiments may be used on any size closer having any desired tube diameter. Accordingly, the exemplary embodiments are intended to embrace all such alternatives, modifications and variances which fall within the scope of the appended claims.

1. A door closing actuator for closing a door in a frame, the door closing actuator comprising:
a cylinder having a first end adapted to be attached to the door or the door frame, the cylinder having a second end opposite the first end and a stop located there between;
a rod movable within the cylinder, the rod protruding from the second end of the cylinder, the rod being attachable to the door or the door frame; and
a locking device movably connected to the cylinder for locking the rod relative to the cylinder, the locking device having a locking member and an actuation member, the actuation member having a locking member contact portion adapted to contact the locking member, and the locking member being disposed in the cylinder between the second end and the contact portion;
wherein, the actuation member engages and moves the locking member from a free position to a locking position in which the locking member engages the rod, and wherein movement of the rod relative to the cylinder with the locking member in the locking position causes the actuation member to disengage the locking member and further causes the locking member to engage the stop of the cylinder.

2. The door closing actuator of claim 1, wherein the locking device is coupled to the second end, and wherein the stop is stationary relative to the cylinder, and wherein engagement between the locking member and the stop stops movement of the rod relative to the cylinder.

3. The door closing actuator of claim 1, further comprising a spring mounted to the cylinder and engaging the locking member, wherein the spring urges the locking member toward the free position.

4. The door closing actuator of claim 1, further comprising a bias spring mounted to the cylinder and urging the locking member toward the free position, the bias spring being positioned offset from the rod so that the bias spring is between the rod and one side of the cylinder and the rod does not extend through the bias spring.

5. The door closing actuator of claim 4, wherein the bias spring is located on an opposite side of the rod from the actuation member and wherein, the actuation member overcomes the spring when moving the locking member from the free position to the locking position.

6. The door closing actuator of claim 1, wherein the locking member engages the cylinder so that the locking member is movably held by a peripheral wall of the cylinder.

7. The door closing actuator of claim 1, wherein the cylinder comprises a housing assembly within a wall of the cylinder, the locking device being coupled to the housing assembly, and the rod passing through the locking member within the split housing.

8. The door closing actuator of claim 1, wherein the second end axially guides the rod, and wherein the second end axially positions the locking member concentric with a centerline of the rod when the locking member is in the free position.

9. The door closing actuator of claim 1, wherein the actuation member protrudes from a side of the cylinder and is movable in and out of the cylinder, through a side wall of the cylinder to engage and disengage the locking member.

10. A door closing actuator for closing a door in a frame, the door closing actuator comprising:
a cylinder having a first end adapted to be attached to the door or the door frame, the cylinder having a second end opposite the first end and a wall connecting the first and second ends between;
a piston assembly within the cylinder, the piston assembly having a rod protruding from the second end of the cylinder, the rod being attachable to the door or the door frame; and
a locking device movably connected to the cylinder for locking the rod to the cylinder, the locking device having a locking member and an actuation member capable of actuating the locking member from an unlocked to a locked position in which the locking member engages the rod;
wherein the locking member engages and is movably mounted on the wall of the cylinder.

11. The door closing actuator of claim 10, wherein the locking member is located in the second end and movably held by the cylinder in a free position without contacting the rod, wherein the second end axially guides the rod and axially positions the locking member substantially concentric with a centerline of the rod when the locking member is in the free position, and wherein movement of the actuation member from an unlocked position to a locked position moves the locking member from the free position to a locking position in which the locking member substantially locks on the rod.

12. The door closing actuator of claim 10, wherein the second end has an interior surface adapted to movably hold the locking member, the interior surface being shaped to contact the locking member around a periphery of the locking member and mount the locking member on the cylinder without contact between locking member and rod.

13. The door closing actuator of claim 10, wherein the locking member has a feature engaging a portion of the second end and preventing rotation of the locking member relative to the cylinder about a centerline of the rod.

14. The door closing actuator of claim 10, wherein the actuation member is spring loaded against the locking member when actuating the locking member.

15. The door closing actuator of claim 10, wherein the actuation member extends from inside the cylinder to outside the cylinder through the wall, and is movable in an axial direction relative to the rod.

16. The door closing actuator of claim 15, wherein the actuation member is movable relative to the cylinder between an outer and inner position, and wherein inward movement of the rod relative to the cylinder with the locking member in a locking position, urges the actuation from the inner to the outer position and member disengages the actuation member from the locking member.

17. A door closing actuator for closing a door in a frame, the door closing actuator comprising:
a cylinder having a first end adapted to be attached to the door or the door frame, the cylinder having a second end opposite the first end and a stop located there between;
a piston assembly within the cylinder, the piston assembly having a rod protruding from the second end of the cylinder, the rod attachable to the door or the door frame;
the piston assembly spring loaded against the cylinder and applying a returning force to urge the door to a closed position within the frame; and
a locking device movably connected to the cylinder for locking the rod relative to the cylinder, the locking device having a locking member and an actuation member, the actuation member having a locking member engagement surface adapted to engage the locking member and move the locking member to lock on the rod, the engagement surface being disposed in the cylinder so that movement of the rod into the cylinder when the locking member is locked to the rod moves the locking member towards the engagement surface;
wherein, the locking member engages the stop stopping movement of the rod into the cylinder, and wherein the stop is different and separate from the engagement surface on the actuation member.

18. The door closing actuator of claim 17, wherein the actuation member has a first position and a second position, the actuation member engaging the locking member to lock the locking member to the rod when in the second position, and wherein movement of the rod into the cylinder with the locking member locked to the rod moves the actuation member to the first position, and wherein movement of the rod out of the cylinder releases the lock between the locking member and rod and disengages the locking member from the rod.

19. The door closing actuator of claim 18, wherein the actuation member is spring loaded against the locking member when in the second position and wherein the rod has a roughened contact surface disposed for engagement by the locking member.

20. The door closing actuator of claim 17, wherein the actuation member is spring loaded radially outward relative to the rod, and wherein the rod extends through the locking member without contact between the rod and locking member when the locking member is not locked to the rod.

21. The door closing actuator of claim 17, further comprising a bias spring biasing the locking member toward an unlocked position, the spring being positioned offset from the rod and on an opposite side of the rod relative to the actuation member, the rod extending substantially parallel to the spring without extending through the spring.
